(19) United States
(12) Patent Application Publication
(10) Pub. No.: US 2015/0352894 A1
(43) Pub. Date: Dec. 10, 2015

(54) Method for Creating a Precoated Board that will Produce Three Dimensional Liquid Art on a Surface

(71) Applicant: Ryan M. Stewart, Scottsdale, AZ (US)

(72) Inventor: Ryan M. Stewart, Scottsdale, AZ (US)

(21) Appl. No.: 14/724,712

(22) Filed: May 28, 2015

Related U.S. Application Data
(60) Provisional application No. 62/007,784, filed on Jun. 4, 2014.

(51) Int. Cl. B44F 7/00; B44D 5/00

(52) U.S. Cl. CPC B44F 7/00; B44D 5/00

(57) ABSTRACT

The embodied invention is to create a precoated board for commercial sale that will create three dimensional liquid art when a consumer pours a suitable liquid (such as water) onto a board surface. In an embodiment, a hydrophobic coating is applied and then a hydrophilic coating in the shape of art is applied. The liquid naturally collects into the hydrophilic areas of the board to form defined artistic shapes and is repelled by hydrophobic areas. Alternatively, in other embodiments, the board can be selected with a natural hydrophobic surface or a natural hydrophilic surface, and then a hydrophilic coating or a hydrophobic coating, respectively, is applied in an art shape.

### CROSS REFERENCE TO RELATED APPLICATIONS

This application claims the benefit of U.S. Provisional Application No. 62/007,784, filed on Jun. 4, 2014. The entire provisional application is included herein by reference.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

(1) Field of the Invention

The embodied invention is directed at art, in particular temporary art that is created for decorative and festive events, or more serious artistic expressions. It is three dimensional by the nature of the medium, as it is liquid based such as water, which has a thickness.

(2) Description of Related Art

Others have worked in three dimensional liquid art. For example, use of a spray on hydrophobic coating allows for people to stencil off areas, to provide for areas without a hydrophobic coating. After drying, the end result is that areas which have a hydrophobic coating will repel water, and the stenciled uncoated areas do not. If water is poured onto the uncoated areas, the result is water beading up in the shape of the uncoated area. However, this does not provide the best artistic effect as it is desirable for the surface underneath the water to be a different color.

Others have worked on hydrophobic coatings such as U.S. Pat. No. 6,579,353 and U.S. Pat. No. 5,773,091.

### BRIEF SUMMARY OF THE INVENTION

The embodied invention is to create a precoated board for commercial sale that will create three dimensional liquid art when a consumer pours a suitable liquid (such as water) onto a board surface. The liquid naturally collects into the hydrophilic areas of the board to form defined artistic shapes and is repelled by hydrophobic areas.

In one embodiment, the board surface is covered with both a hydrophobic and hydrophilic coating, in whole or in part, for the purpose of designing a part of the surface to receive a fluid. Paint, particularly enamel paint, is useful as a hydrophilic coating.

In another embodiment, a hydrophilic board is chosen and only a hydrophobic coating is applied and defined artistic areas are left uncoated. The poured liquid is attracted to only the uncoated areas that are naturally hydrophilic. The uncoated area may be created using a stencil to prevent an area from being coated.

Similarly, in still another embodiment, a hydrophobic board is selected and only a hydrophilic coating is applied.

### BRIEF DESCRIPTION OF THE SEVERAL VIEWS OF THE DRAWING(S)

FIGS. 1-4 show a method of coating a board with a hydrophobic coating and the resulting art.

FIGS. 5-8 show s different method of coating a board with a hydrophobic coating and the resulting art.

FIGS. 9-12 show a screen printing method to produce liquid art on a surface.

FIGS. 13-16 show an alternate screen printing method to produce liquid art on a surface.

### DETAILED DESCRIPTION OF THE INVENTION

The method of creating a three dimensional art made from liquid and is done by one of two methods following.

A board is selected for receiving the art. The board could be paper, cardboard, wood, plastic, glass, metal, or a composite. The board has to be strong enough to support the three dimensional art, and also have a suitable surface to receive a hydrophobic coating. It is preferably clean of dirt, debris, oils, and surface contaminates.

A hydrophobic coating, such as NeverWet, is then applied over the entire top surface of the board. It could be painted on, applied with a roller, or preferably, applied by a spray system, such as a spray can. Sufficient coating thickness is applied to provide the desired hydrophobic effect.

After the hydrophobic coating has dried, an enamel paint is applied to the surface of the hydrophobic coating so as to create areas that will receive a water and allow it to bead up. It has been found that hydrophobic coatings will receive paint and allow it to adhere at some level, and the painted areas are very useful to create art.

After the paint has dried, a liquid, such as water, is poured onto the top surface of the board. The water is repelled by the hydrophobic coating and but will congregate on the painted areas. The hydrophobic coating does not always have a perfect effect of repelling the coating, and a little encouragement to congregate in the desired areas may be needed. A finger, a tool, a light volume of moving air will be sufficient to clear the hydrophobic coated areas.

The artwork can then be admired as a striking art medium. It is useful for party decorations, for art displays, and for creating watermarks on heavy paper and cardboard. Inks could also be used for printing on another surface.

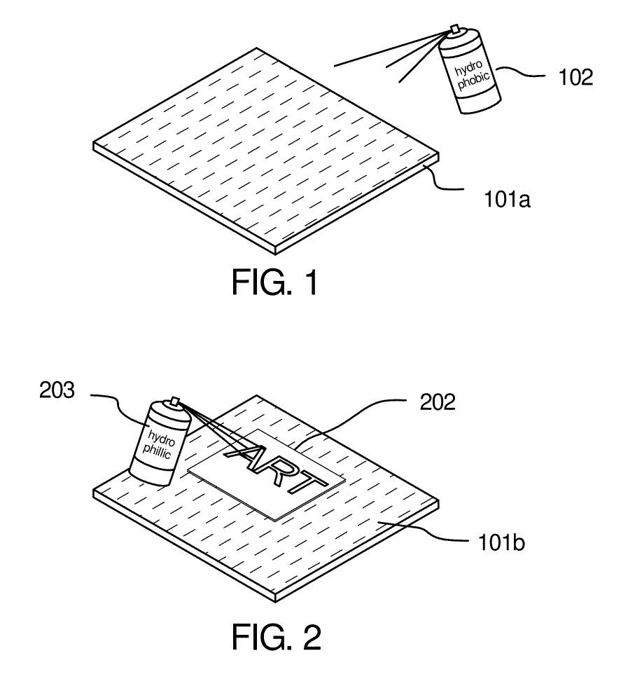

FIG. 1 shows a method of coating a board surface 101a by spraying on a hydrophobic coating from a spray can 102. The board surface 101a must be able to hold a liquid that will be used to create the liquid art work, and also be able to withstand the weight of the applied water. The board could be any of fiber, plastic, glass, wood, metal, concrete, or a composite structure. In a preferred embodiment it is a fiberboard. The hydrophobic coating is sprayed on with a sufficient thickness to create a water repellant coating on the surface of the board.

In FIG. 2, the fiberboard surface 101b is now coated with a dried hydrophobic coating. A stencil 202 with artwork, such as lettering or pictorial images, is placed on top of the fiberboard surface 101b, and a hydrophilic coating from a spray can 203 is sprayed onto the coated fiberboard surface 101b. The stencil is then lifted up and the hydrophilic coating is allowed to dry. The hydrophilic coating is preferably flat enamel paint, and adheres to the fiberboard with sufficient adhesive tackiness so that it will be useful to hold a liquid as further explained.

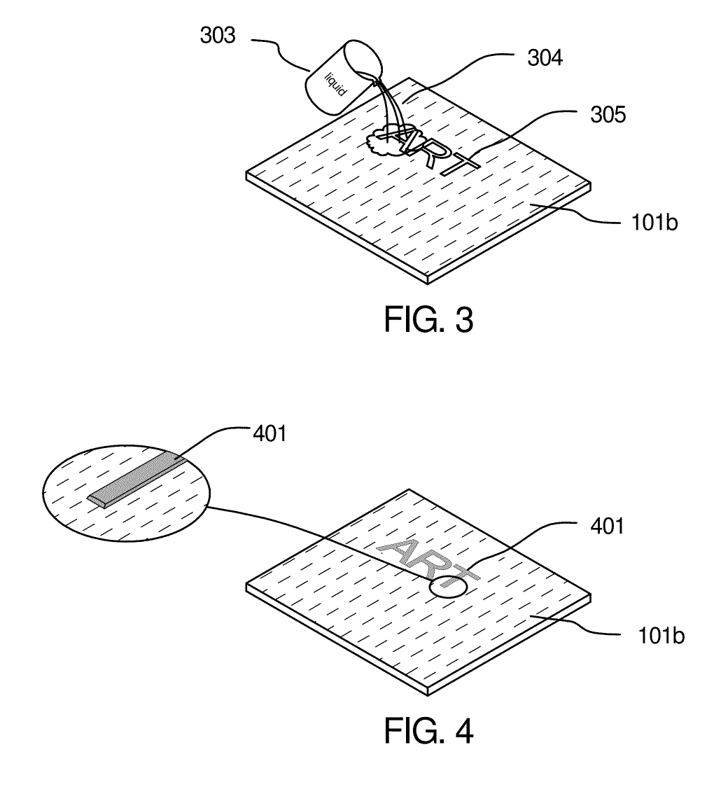

FIG. 3 shows a liquid 304, such as water, being poured out of a container 303 onto the fiberboard surface 101b. In particular, the liquid is poured onto the hydrophilic letters 305 or hydrophilic art that is bonded to the fiberboard surface 101b. The liquid prefers to remain on the lettering, and not the hydrophobic coating on the fiberboard surface. The designer can remove any stray droplets off of the hydrophobic coating by sweeping them off, or by using a light air spray to push the liquid onto the lettering such as compressed air from a can.

FIG. 4 shows liquid art 401 on the fiberboard surface 101b with the stencil removed. The end result is water that remains on top of the lettering, not the board surface, where the water ‘beads up’ or collects together on top of the lettering. The raised letters of water create a unique visual art atheistic, and could be called a three dimensional art or a three dimensional liquid art. The liquid could incorporate various colorants and fillers for a dramatic effect. The enamel paint could also be used to create a visual effect. The painted letters could be a color to contrast with the water or it could also clear. A glass could replace the fiber board for a more artistic expression. One important end result of the art is a ‘magic’ type of effect which will leave observers wondering how it is done. The water strongly tends to create solid lettering (or art) without separating into water beads.

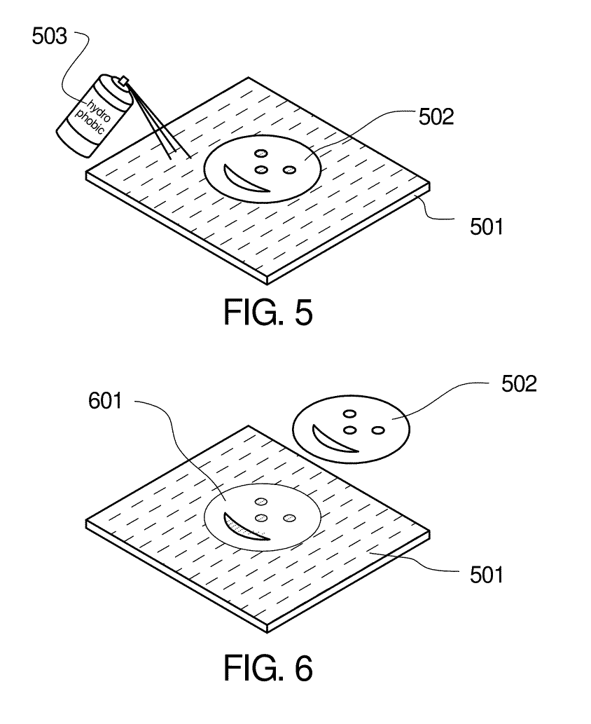

FIG. 5 shows an alternate method to create the three dimensional art when the board surface is naturally hydrophilic. Suitable naturally hydrophilic materials include PVC foamboard or synthetic paper. A stencil 502 is placed on a board surface 501 and a hydrophobic coating 503 is sprayed onto the board surface. The stencil 502 (lettering or artwork) protects a portion of the board from the hydrophobic coating. Again, the board surface 501 will eventually hold the liquid art work and must be suitably strong enough to withstand the weight of the water.

In FIG. 6, the stencil 502 is removed from the fiberboard surface 501 which is coated with the hydrophobic coating, which has now dried. An uncoated area 601 remains, and in this case the eyes and mouth of the artwork are coated with the hydrophobic coating.

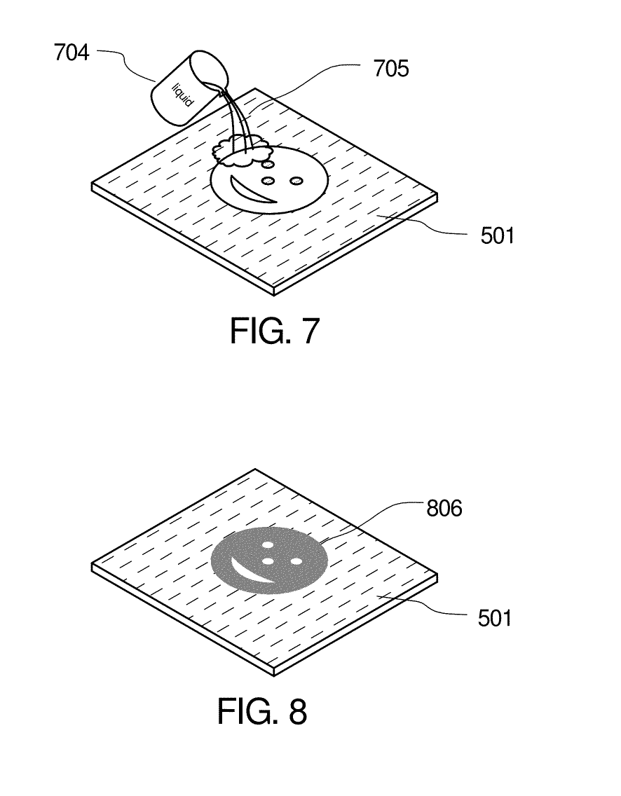

FIG. 7 shows a liquid 705, such as water, being poured out of a container 704 onto the fiberboard surface 501. In particular, the liquid is poured onto the uncoated portion of the board. The liquid prefers to remain on the uncoated area, and not congregate on the dried hydrophobic coating on the fiberboard surface 501.

FIG. 8 shows liquid art 806 on the fiberboard surface 501. As illustrated, the water will collect together and become three dimensional liquid art 806. Again, the liquid could include various colorants (and fillers such as sparkles) for a dramatic effect. The liquid color might be chosen to contrast with the fiberboard surface 501 or it could be a clear coating.

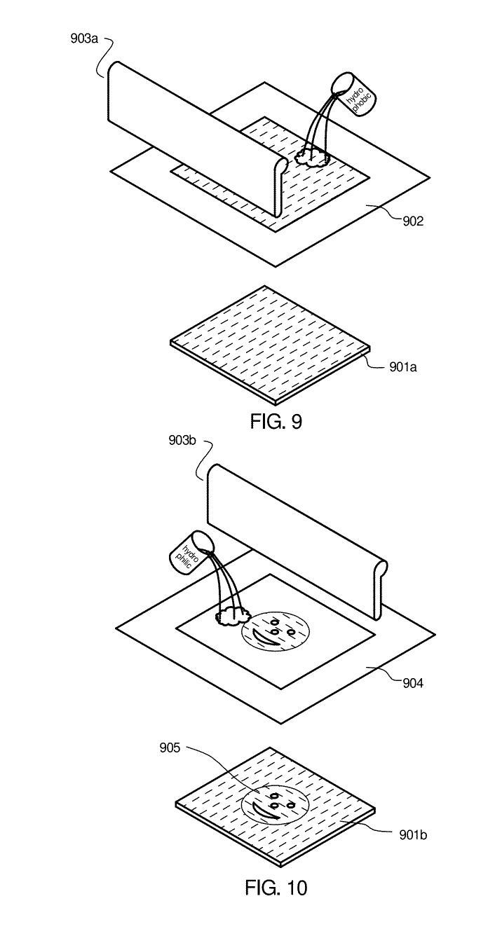

FIG. 9 shows the use of a screen printing method to put on a hydrophobic coating. A squeegee 903a and a mesh screen 902 are used to put a hydrophobic coating on top of a fiberboard surface 901a. FIG. 10 shows the use of a squeegee 903b to coat a screen print with an image 904 onto the coated fiberboard surface 901b. The resulting effect is a hydrophilic coating 905 on top of the hydrophobic coated fiberboard surface 901b with the desired image.

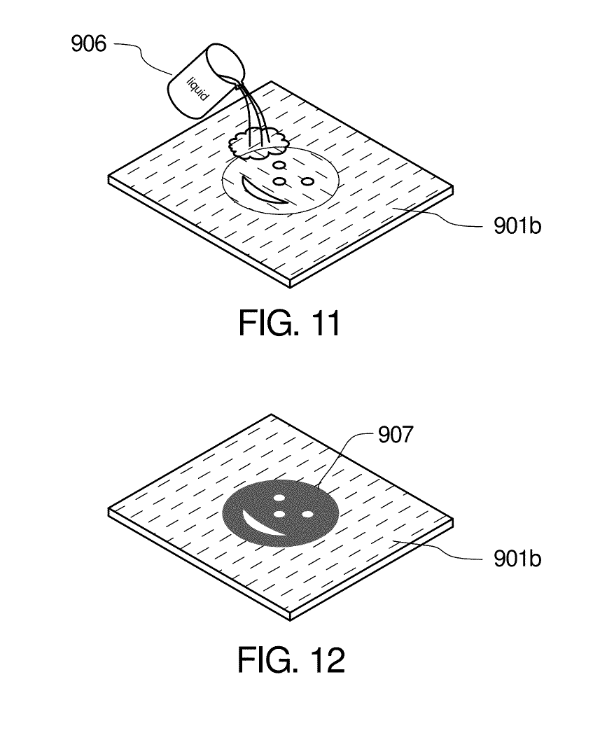

FIG. 11 continues the coating process by showing a liquid container 906 pouring the desired liquid on top of the coated fiberboard surface 901b. FIG. 12 shows the resulting liquid artwork 907.

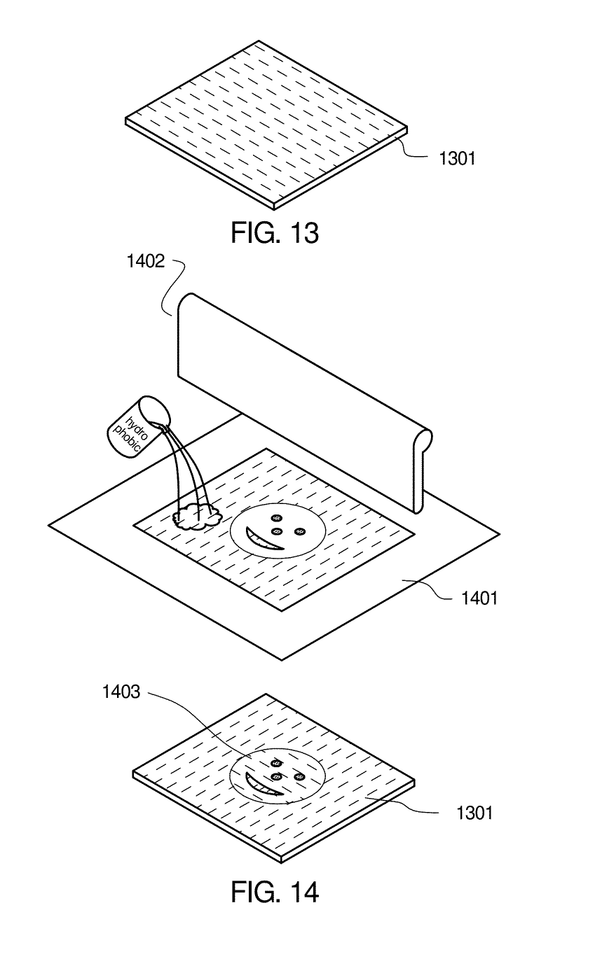

FIG. 13 shows a fiberboard surface 1301 that is naturally a hydrophilic coating. Suitable naturally hydrophilic materials include PVC foamboard or synthetic paper. In this case, there is no need to use a screen print or spray can to add a hydrophilic coating. In FIG. 14, a squeegee 1402 and a screen print image 1401 are used to put a hydrophobic coating 1403 on top of the naturally hydrophilic fiberboard surface 1301 in a manner to allow the area for desired art or letters to be left uncoated.

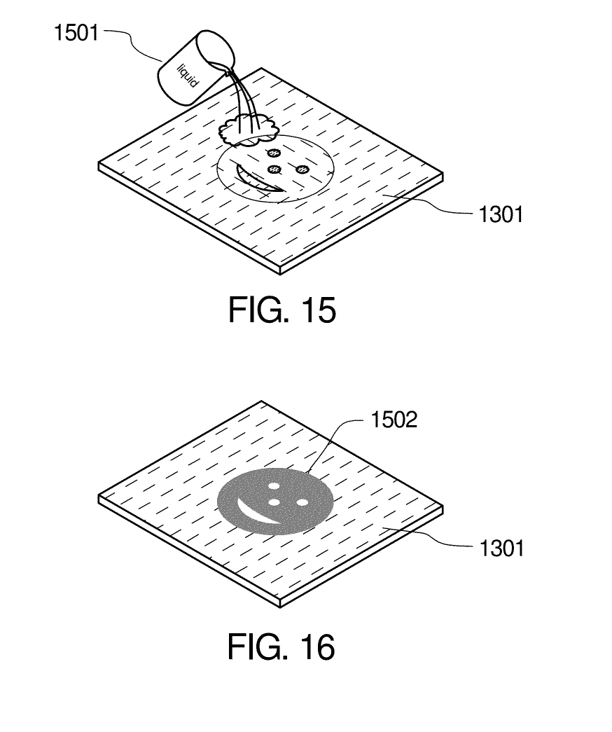

FIG. 15 continues the coating process by showing a liquid container 1501 pouring the desired liquid on top of the naturally hydrophilic fiberboard surface 1301. FIG. 16 shows the resulting liquid artwork 1502.

All methods of creating the three dimensional liquid artwork allow for the hydrophilic coating (or paint) to include a colorant. This allows a more dramatic presentation by using either a clear or colored liquid on top of the hydrophilic coating which may include additional colors or texture. The hydrophilic coating may be applied in multiple layers. This is particularly useful when screen printing is used.

In addition, whenever a hydrophobic coating is applied, it optionally includes colors and artwork. It may be applied in multiple layers for a dramatic effect. This is particularly useful when screen printing is used.

In any of the four methods, (i.e. FIGS. 1-4, FIGS. 5-8, FIGS. 9-12, and FIGS. 13-16) a second party that applies the liquid is performed separately from a first party that applies the hydrophobic and hydrophilic coatings. This is especially useful when the first party sells a precoated board commercially so as to allow a second party (i.e. consumer) to purchase a prepared artwork board created by the first party, and then the second party adds the finishing touch of liquid. In this case, screen printing is a desirable method so as to lower costs.

In addition, the art design of the board (i.e. any colors, patterns, etc. in the hydrophobic or hydrophilic coatings) may be purposefully chosen so that a second party will apply a colored liquid for the desired artistic effect.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A method of selling a precoated board that is capable of displaying a three dimensional liquid art by the steps comprising:
A) a first party selects a board made of material suitable for supporting a liquid and receiving a hydrophobic coating on its surface,
B) said first party applies said hydrophobic coating on the top surface of said board thereby creating a first coated board,
C) said first party applies a paint on said first coated board in the shape of artwork thereby creating a second coated board,
D) said first party commercially sells said second coated board to a second party, and
E) said first party designs any applied coatings on said first coated board and said second coated board so that said second party is able to:
i) pour a liquid on said second coated board,
ii) maneuver said liquid so as to ensure that at least a portion of said liquid remains substantially on said paint on top of said second coated board, and
iii) display said three dimensional liquid art on said second coated board in the shape of said artwork.

2. The method according to claim 1 wherein at least one item from the group consisting of:
A) said liquid,
B) said paint, and
C) said hydrophobic coating,
includes a colorant.

3. The method according to claim 2 wherein said paint is flat enamel paint.

4. A method of selling a precoated board that is capable of displaying a three dimensional liquid art by the steps comprising:
A) a first party selects a board made of material suitable for supporting a liquid and receiving a hydrophobic coating on its surface,
B) wherein a top surface of said board is naturally hydrophilic,
C) said first party places a stencil on a top surface of said board in the shape of artwork,
D) said first party applies said hydrophobic coating on a top surface of said board and ensures said top surface remains substantially uncoated only underneath said stencil thereby creating a first coated board,
E) said first party removes said stencil,
F) said first party commercially sells said second coated board to a second party, and
G) said first party designs any applied coatings applied to said first coated board so that said second party is able to:
i) pour a liquid on said first coated board,
ii) maneuver said liquid so as to ensure that at least a portion of said liquid remains substantially on any uncoated area on said first coated board, and
iii) display said three dimensional liquid art on said first coated board in the shape of said artwork.

5. The method according to claim 4 wherein at least one item from the group consisting of:
A) said liquid
B) said hydrophobic coating, and
C) said top surface of said board,
includes a colorant.

6. A method of selling a precoated board that is capable of displaying a three dimensional liquid art by the steps comprising:
A) a first party selects a board made of material suitable for supporting a liquid and receiving a hydrophobic coating on its surface,
B) said first party applies said hydrophobic coating on the entirety of a top surface of said board by use of a screen printing method thereby creating a first coated board,
C) allowing said hydrophobic coating on said first coated board to dry,
D) said first party screen prints a hydrophilic coating on top of said first coated board in the shape of artwork thereby creating a second coated board,
E) allowing said hydrophobic coating on said second coated board to dry,
E) said first party commercially sells said second coated board to a second party, and
F) said first party designs any applied coatings on said first coated board and said second coated board so that said second party is able to:
i) pour a liquid on said second coated board,
ii) maneuver said liquid so as to ensure that at least a portion of said liquid remains substantially on said hydrophilic coating on top of said second coated board, and
iii) display said three dimensional liquid art on said second coated board in the shape of said artwork.

7. The method according to claim 6 wherein at least one item from the group consisting of:
A) said liquid.
B) said hydrophobic coating, and
C) said hydrophilic coating,
includes a colorant.

8. A method of selling a precoated board that is capable of displaying a three dimensional liquid art by the steps comprising:
A) a first party selects a board made of material suitable for supporting a liquid and receiving a hydrophobic coating on its surface,
B) wherein a top surface of said board is naturally hydrophilic,
C) said first party screen prints said hydrophobic coating on top of said board to provide uncoated areas in the shape of artwork thereby creating a first coated board,
E) allowing said hydrophobic coating on said first coated board to dry,
F) said first party commercially sells said first coated board to a second party, and
G) said first party designs any applied coatings applied to said first coated board so that said second party is able to:
i) pour a liquid on said first coated board,
ii) maneuver said liquid so as to ensure that at least a portion of said liquid remains substantially on said uncoated areas on top of said first coated board, and
iii) display said three dimensional liquid art on said first coated board in the shape of said artwork.

9. The method according to claim 8 wherein at least one item from the group consisting of:
A) said liquid,
B) said top surface of said board, and
C) said hydrophobic coating,
includes a colorant.

10. The method according to claim 9 wherein said board is PVC foamboard or synthetic paper.

11. The method according to claim 5 wherein said board is PVC foamboard or synthetic paper.
